(19) United States
(12) Patent Application Publication
(10) Pub. No.: US 2011/0132114 A1
(43) Pub. Date: Jun. 9, 2011

(54) VIBRATION APPARATUS FOR A HAND-HELD MOBILE DEVICE, HAND-HELD MOBILE DEVICE COMPRISING THE VIBRATION APPARATUS AND METHOD FOR OPERATING THE VIBRATION APPARATUS

(75) Inventor: Georg Siotis, Lund (SE)

(73) Assignee: Sony Ericsson Mobile Communications AB, Lund (SE)

(21) Appl. No.: 12/630,355

(22) Filed: Dec. 3, 2009

(51) Int. Cl. B06B 1/16

(52) U.S. Cl. 74/87

(57) ABSTRACT

The present invention relates to a vibration apparatus, a hand-held mobile device and a method for operating the vibration apparatus with which the time to obtain a detectable vibration effect is reduced while still being able to provide also a strong vibration effect. The vibration apparatus comprises a first weight member; a second weight member; a driving section coupled to said first weight member and operable to rotate at least said first weight member around a rotation axis; and a coupling mechanism adapted to provide coupling between said first weight member and said second weight member so that in a first state said first weight member is rotated by said driving section and in a second state said first weight member and said second weight member are rotated by said driving section.

### FIELD OF THE INVENTION

The present invention relates to a vibration apparatus, a hand-held mobile device and a method for operating the vibration apparatus, and in particular to a vibration apparatus comprising a driving section for moving or rotating at least one weight member.

### BACKGROUND

Conventionally vibrator apparatuses, in particular vibrator apparatuses for mobile phones, are used with a rather large counterweight to run at approximately 9000 rpm (revolutions per minute) and produce an easily detectable vibration effect at approximately 150 Hz. This vibration effect is used to alert a user of a mobile device, such as a mobile phone, of a scheduled appointment, an incoming call, a set alarm time, etc., when the user carries the mobile device in his pocket, for example. Such vibration effects are particularly useful when the environment, in which the user is in, is noisy or the user is otherwise hindered from hearing an alert sound of the mobile device. For example, there are also situations, in which a user of a mobile phone tries to avoid a ringing sound, such as in a meeting, but still wants to be informed of an incoming call or similar.

According to the above, it is desirable that the vibration effect is quite large so that the alert is not missed. In other words, vibration has to provide haptic feedback to the user to an extent, which the user can sense either on his body, when carrying the mobile device in his/her pocket or even when the mobile device is placed in a handbag so that the movement of the handbag due to the vibration can be felt.

However, if the counterweight is large and thus the vibration effect is strong, the acceleration of the mass of the counterweight to bring it into fast rotation may be slow so that a detectable vibration effect may be delayed for up to one second.

This may be unproblematic in the alert cases described above, in which the user does not respond and is not expected to respond immediately, i.e. in a second. However, there may be different cases, e.g. haptic applications, in which fast acceleration and thus a detectable vibration effect is needed in a very short time, e.g. below one second.

For example, vibration can be used as an acknowledgement of a user input into a user interface. In particular, when a touch screen is used as a user interface, the icons on the display, such as virtual button or keys, do not commonly provide the user with a response that can be directly sensed, such as a real keyboard or real buttons. Therefore, vibration of the device having the touch screen incorporated therein may be provided to acknowledge touching an icon on the touch screen.

However, when a standard vibration apparatus is used in such an application, the results of feedback are poor due to the time it takes for the vibrator motor to come up to these haptic detectable frequencies at high vibration amplitudes. Since haptic applications often require short confirmations of buttons pressed, menus chosen or functions activated and are integral part of user interface design and user experience, the standard vibrator apparatus does not sufficiently fulfil the requirements for haptic applications.

Therefore, it is desirable to provide an improved vibration apparatus for a hand-held mobile device, a hand-held mobile device with a vibration apparatus and a method for operating the same with which the time to obtain a detectable vibration effect is reduced.

### DISCLOSURE OF THE INVENTION

A novel vibration apparatus, mobile device comprising the vibration apparatus and method for operating the vibration apparatus are presented and defined in the independent claims. Advantageous embodiments are defined in the dependent claims.

An embodiment of the invention provides a vibration apparatus for a hand-held mobile device. The vibration apparatus comprises a first weight member, a second weight member and a driving section coupled to the first weight member and operable to rotate at least the first weight member around a rotation axis. Further, the vibration apparatus comprises a coupling mechanism adapted to provide coupling between the first weight member and the second weight member so that in a first state the first weight member is rotated by the driving section and in a second state the first weight member and the second weight member are rotated by the driving section.

Accordingly, by using two different weight members as counterweights different vibration effects to provide haptic feedback to a user can be obtained that may be chosen depending on the application. For example, if a strong vibration effect for an alert of e.g. an incoming call is required, the first weight member and the second weight member can be coupled and if a small vibration effect but quickly detectable vibration effect is required, the first weight member may be rotated alone. Therefore, it can be avoided to use two vibration apparatuses with different weight member sizes so that costs and space in a mobile device can be reduced.

In one embodiment, the vibration apparatus is adapted to generate a mechanical force to provide haptic feedback to a user by rotation of at least one of the weight members. Accordingly, it can be chosen from one or two weight members so that different haptic feedback can be sensed by the user based on the haptic application needed.

In one embodiment, the mass of the first weight member is smaller than the mass of the second weight member and in the first state the vibration apparatus is adapted to generate a weak mechanical force and in the second state the vibration apparatus is adapted to generate a stronger mechanical force. Accordingly, the first state situation can be used for acknowledging or confirming a user input in a touch screen since the small mass of the first weight member may be quickly accelerated to detectable frequencies, and the second state situation can be used to alert a user of an incoming call or similar when the user does not wait for a vibration, e.g. when waiting for an acknowledgment of an operation, and thus a strong vibration effect to get the user's attention is needed.

In one embodiment, the coupling mechanism is adapted to provide coupling between the first weight member and the second weight member so that in the first state the first weight member is rotated in the first direction and in the second state the first weight member and the second member are rotated in an opposite second direction. In particular, it is desirable that the driving section is adapted to change the direction of rotation depending on electric energy supplied thereto so as to provide first haptic feedback in the first direction and second haptic feedback in the second direction. Accordingly, the type of haptic feedback can be easily chosen by the direction of rotation, wherein the direction of rotation can be easily changed by the electric energy supplied to the driving section, for example, by the polarity of the supplied voltage.

In one embodiment, the mass of at least one of the first and second weight members is distributed non-uniformly in the at least one of the first and second weight members. Accordingly, the more non-uniform mass is distributed around the rotation axis, the larger the detectable vibration effect due to unbalanced mass.

In one embodiment, the driving section comprises a shaft, and the first weight member is attached to the shaft. Preferably, the shaft is off-centered from the center of mass of the first weight member. Accordingly, strong vibration effects can be obtained due to unbalanced mass.

In one embodiment, the first weight member and the second weight member have substantially cylindrical shape, and the second weight member is arranged around the first weight member. Accordingly, a simple and compact construction of the vibration apparatus is obtainable so that the space required for the vibration apparatus in a mobile device, for example, is small.

In one embodiment, the coupling mechanism comprises an engaging section between the first weight member and the second weight member to couple the second weight member and the first weight member. In one specific example, the engaging section is adapted to couple the second weight member and the first weight member so that coupling is always performed at the same position of the weight members. Accordingly, if weight members of non-uniform mass distribution are used, the orientation of the two weight members can be chosen so that both vibration effects of both members due to non-uniformity of mass are added up.

In another example, the engaging section comprises a ratchet or one-way clutch so that the second weight member and the first weight member engage when the first weight member rotates in the opposite second direction and disengage when the first weight member rotates in the first direction. Accordingly, a simple coupling mechanism is provided to obtain different vibration effects in different directions.

In one embodiment, the coupling mechanism comprises an electro-magnet to move the first weight member in the direction of the rotation axis relative to the second weight member. Accordingly, a mechanism can be provided to engage or disengage the two weight members by linear movement in the direction of the rotation axis.

Another embodiment of the invention provides another vibration apparatus for a hand-held mobile device. The vibration apparatus comprises a first weight member, a second weight member and means for driving a movement coupled to the first weight member and operable to move at least the first weight member around a rotation axis. Further, the vibration apparatus comprises means for providing coupling between the first weight member and the second weight member so that in a first state the first weight member is moved by the means for driving a movement and in a second state the first weight member and the second weight member are moved by the means for driving a movement. Accordingly, by either moving one or two weight members different vibration effects can be obtained. Further, a movement can be either a rotation or a linear movement, such as a reciprocating motion of the first weight member or of both weight members.

Another embodiment of the invention provides a hand-held mobile device comprising one of the above-described vibration apparatuses.

Another embodiment of the invention provides a method for operating a vibration apparatus, such as one of the above-described vibration apparatuses. The method comprises the steps of rotating a first weight member in a first state around a rotation axis by a driving section coupled to the first weight member; coupling said first weight member and a second weight member; and rotating said first weight member and said second weight member by said driving section in a second state.

### BRIEF DESCRIPTION OF THE DRAWINGS

Embodiments of the invention will be described with respect to the following appended figures.

FIG. 1 illustrates a vibration apparatus and elements thereof according to an embodiment of the invention.

FIG. 2 illustrates a vibration apparatus and elements thereof according to another embodiment of the invention.

FIG. 3 illustrates a side view of a vibration apparatus and elements thereof according to an embodiment of the invention.

FIG. 4 illustrates a mobile device having a vibration apparatus incorporated therein according to another embodiment of the invention.

FIG. 5 illustrates a flow diagram of a method for operating a vibration apparatus according to an embodiment of the invention.

### DESCRIPTION OF THE EMBODIMENTS

Embodiments of the invention are described with reference to the figures. It is noted that the following description contains examples only and should not be construed as limiting the invention.

In the following, similar or same reference signs indicate similar or same elements.

As mentioned above, it is desirable to provide a vibration apparatus for a mobile device with which the time to obtain a detectable vibration effect is reduced. When shortening the delay time with a smaller counterweight, vibration of a mobile device would be hard to sense. In this case, the extent of the vibration effect may not be sufficient to be detectable when a mobile device is not held in the user's hand but temporarily stored in his/her pocket, for example. Therefore, a vibration apparatus with a strong vibration effect and a quick response time is needed.

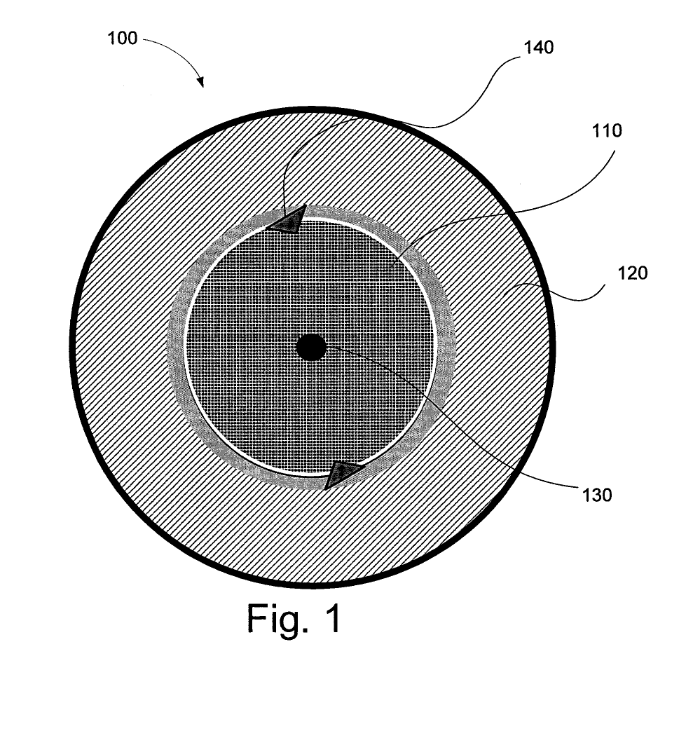

FIG. 1 illustrates elements of a vibration apparatus according to an embodiment of the invention. The vibration apparatus 100 of the FIG. 1 comprises a first weight member 110, a second weight member 120, a driving section 130 and a coupling mechanism 140.

The vibration apparatus 100 may be used in a hand-held mobile device, such as a cellular phone or other type of mobile phone, personal digital assistant (PDA), game controller, or other mobile device, in which vibrational feedback to a user is desired.

In the embodiment shown in FIG. 1, the first weight member 110 has a cylindrical shape and is arranged to rotate around a rotation axis to serve as a first counterweight.

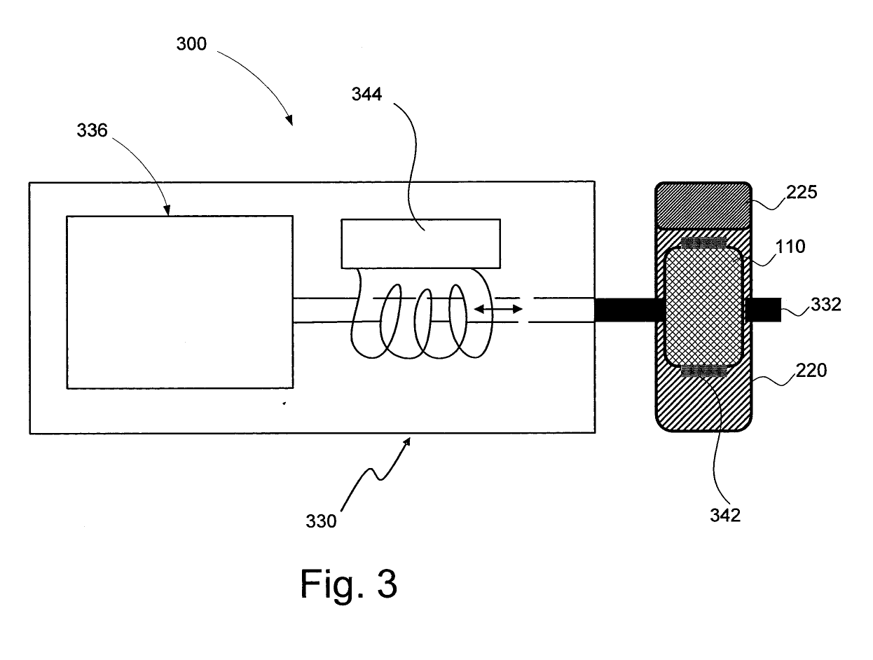

The second weight member 120 is preferably arranged around the first weight member 110 as can be seen in FIG. 1. In this example, the second weight member 120 serving as a second counterweight is substantially of cylindrical shape with an opening in the center region to be able to receive the first weight member 110. For a better understanding of the construction of the vibration apparatus 100, it may also be referred to FIG. 3 showing a side view of a similar vibration apparatus which will be discussed later.

The driving section 130 is coupled to the first weight member 110 and operable to rotate at least the first weight member 110 around a rotation axis. For example, the driving section 130 is an electric motor having a motor axis serving as a shaft (visible in FIG. 1) to which the first weight member 110 can be attached as can be seen in FIG. 1. For example, the motor axis can be fixed to the first weight member 110 permanently by using an adhesive or press fit or temporarily by set screws or similar ways.

The coupling mechanism 140 provides coupling between the first weight member and the second weight member. In detail, the coupling mechanism 140 is adapted so that in a first state the first weight member 110 can be rotated when the motor axis driven by the motor of the driving section 130 is rotated and in the second state the first weight member 110 and the second weight member 120 are coupled to rotate together around the rotation axis when the motor axis is driven.

In other words, the coupling mechanism 140 provides coupling between the first weight member 110 and the second weight member 120 so that in the first state the first weight member is rotated by the driving section 130 and in the second state the first weight member 110 and the second weight member 120 are rotated by the driving section 130.

Providing coupling between the first weight member 110 and the second weight member 120 can be realized in several different ways. For example, an engaging section can be provided between the weight members which will be described in more detail below.

The vibration apparatus generates a mechanical force to provide haptic feedback to a user by rotation of at least one of the weight members. Here, haptic feedback is understood as the vibration effect produced by the vibration apparatus 100 that can be sensed by a user. It is understood that the extent of a vibration effect depends on several factors, and particularly how the mass of the weight members is distributed with respect to the rotation axis. It is noted that even optimally designed electro-motors produce vibration, and in the vibration apparatus described herein, vibration is desired and enhanced by using weight members as counterweights.

In the example of FIG. 1, the mass of the first weight member 110 is smaller than the mass of the second weight member 120 so that in the first state, in which the first weight member is not coupled to the second weight member, the vibration apparatus 100 is adapted to generate a first mechanical force, and in the second state, in which the first weight member 110 and the second weight member 120 are coupled, the vibration apparatus 100 is adapted to generate a stronger second mechanical force.

Since the mass of the first weight member is smaller, also the force needed for acceleration, in this case a torque of the electric motor, does not need to be very high, that is smaller than the force needed to accelerate the second weight member 120 together with the first weight member 110. In other words, the first weight member 110 may be quickly accelerated in a very short time to a frequency of 150 Hz, for example, so that a vibration effect is easily and quickly detectable.

In contrast thereto, accelerating both weight members at the same time to the same frequency may take a longer time and haptic detectable frequencies cannot be detected as quickly. However, the strength of the vibration effect is greater.

Therefore, the vibration apparatus 100 provides for weak but quickly detectable vibration and strong vibration with a small time lag. Accordingly, these two different vibration states can be used for different purposes, such as the first state to quickly acknowledge an input in a user interface such as a touch screen by a user and the second state to alert a user of an incoming call, if the mobile device is a mobile phone, which is for example in the pocket of the user.

In one example, the coupling mechanism is adapted to provide coupling between the first weight member 110 and the second weight member 120 so that in the first state the first weight member 110 is rotated in a first direction, e.g. clockwise, and in the second state the first weight member 110 and the second weight member 120 are rotated in an opposite second direction, e.g. counter-clockwise. To achieve coupling in one direction and not in the other direction a ratchet or one-way clutch may be used between the weight members, which will be described later.

Further, the direction of rotation of the motor axis of the driving section 130 may be changed depending on the electric energy supplied thereto, e.g. the polarity of applied voltage may be switched. Therefore, first haptic feedback may be provided in the first direction and second haptic feedback in the second direction, which is stronger than the first haptic feedback, since two weight members are rotated.

It is understood that the vibration apparatus 100 of FIG. 1 is just an example and the invention is not limited to cylindrical weight members and their placement on top of each other. For example, the weight members may also have a substantially square shape or polygonal shape. In particular, weight members with a polygonal shape may also be placed on top of each other similar to the example of FIG. 1.

However, the invention is not limited thereto and the first and second weight members may also be placed next to each other in the longitudinal direction of the rotation axis. In this case, one weight member can be fixed to the motor axis and the second weight member to a bearing, e.g. on the motor axis so that the second weight member does not rotate when the motor axis rotates. Then, the coupling mechanism may be provided on the side faces of the first weight member and the second weight member facing each other and depending on a first state or a second state the weight members can be coupled with each other.

Furthermore, instead of rotational movement, vibration may also be obtained by a linear movement of the weight members. For example, the driving section may serve as a means for driving a movement which is coupled to the first weight member and operable to move the first weight member, e.g. in a reciprocating motion.

Additionally, the coupling mechanism may serve as a means for providing coupling between the first weight member and the second weight member so that in a first state the first weight member is moved by the means for driving a movement and in a second state the first weight member and the second weight member are moved by the means for driving a movement.

In this example, it is feasible that, similar to the above vibration effects, a reciprocating motion of the first weight member is used to obtain a small vibration effect which is quickly detectable and by moving back and forth both weight members at the same time a stronger vibration effect but with a small time lag may be obtained for an alert.

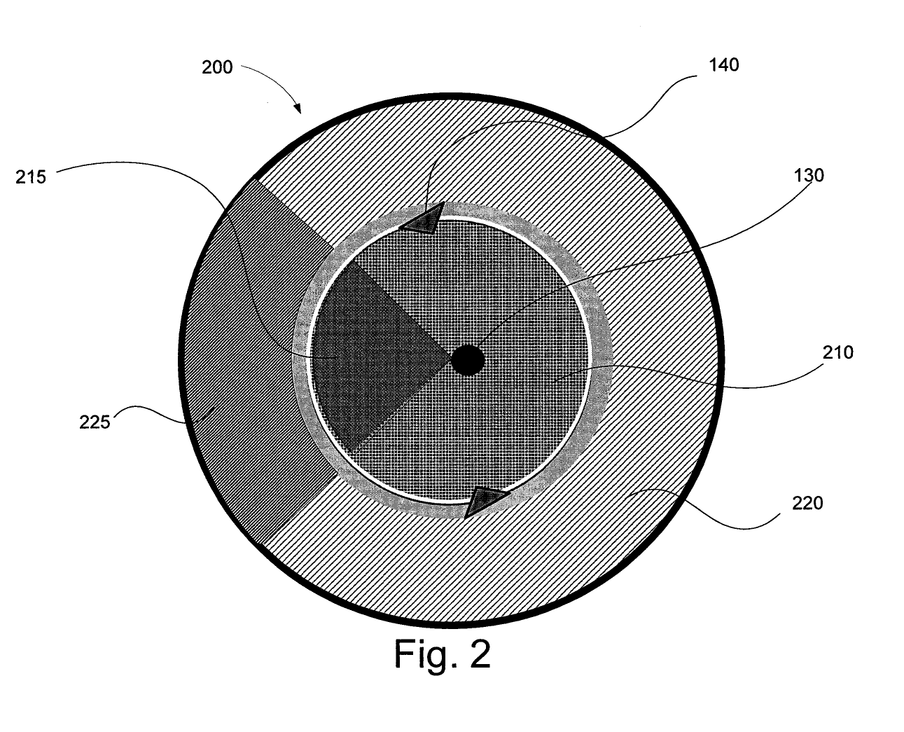

As described above, there are several ways to increase the vibration effect generated by a vibration apparatus. For example, the motor axis constituting a shaft to drive rotation of the weight members, is off-centered, i.e. eccentric, from the center of mass of the first weight member or/and the second weight member. Another example to enhance the vibration effect will be described with respect to FIG. 2.

In FIG. 2 a vibration apparatus similar to the one shown in FIG. 1 is illustrated. The vibration apparatus 200 of FIG. 2 also comprises a first weight member 210, a second weight member 220, a driving section 130 and a coupling mechanism 140. However, in this example, the first weight member 210 is formed of two parts and also the second weight member 220 is formed of two parts. Here, the mass of both the first and second weight members is distributed non-uniformly in the first and second weight members. In detail, the non-uniform distribution is non-uniform with respect to the rotation axis, as can be seen in FIG. 2. It is understood that in another example the non-uniform distribution may also be present in only one of the weight members.

For example, different metals can be used for the two parts of the first weight member and similarly also for the two parts of the second weight member, such as aluminium for the large part shown in FIG. 2 and lead or iron for the other part 215 and 225, respectively.

Therefore, the vibration apparatus of FIG. 2 basically provides an unbalanced mass on the drive shaft by distributing the mass unequally in the cylindrically shaped weight member 210 and similarly on the weight member 220.

As described with respect to FIG. 1, the coupling mechanism 140 comprises an engaging section between the first weight member and the second weight member to couple the second weight member and the first weight member. In this example, the engaging section comprises a ratchet 140 as coupling mechanism so that the second weight member 220 and the first weight member 210 engage when the first weight member 210 rotates in the second direction and disengage when the first weight member rotates in the opposite first direction.

Similarly, also a one-way clutch may be used instead of a ratchet or other mechanisms, such as a simple plate fixed on one side so that when it is rotated in the direction of the one side of the first weight member, the plate remains flat on the first weight member and when it rotates to the other side, the inertia of the rotation moves the plate outwards so that it engages with a notch or other small opening on the second weight member 220 so that both weight members are coupled and are rotated.

To protect the first weight member 210 from dust and for easier mounting of an engaging section, e.g. a ratchet, thereon, a protection cylinder around the first weight member 210 may be provided between the two weight members. In particular, this cylinder may be adapted so that also non-cylindrical weight members, e.g. polygonal, can be placed on top of each other. Furthermore, the engaging section is preferably adapted to couple the second weight member and the first weight member so that coupling is always performed at the same position of the weight members, as can be seen in FIG. 2, preferably so that the heavier parts 215 and 225 are lined up in the same radial direction to increase the unbalance and thus the vibration effect.

For stability purposes, the second weight member 220 serving as the large counterweight may be surrounded and attached to a bearing. This bearing may also be useful to keep the second weight member in place when only the first weight member 210 is rotating or to allow rotation of the second weight member 220 when both weight members are rotating. To switch between the first state and the second state, a break may be provided cooperating with the second weight member to effectively block rotation.

In the following, a side view of a vibration apparatus is described with respect to FIG. 3. The vibration apparatus 300 depicted in the side view of FIG. 3 is basically the same as the vibration apparatus 100 or 200 of FIGS. 1 and 2, respectively only that in FIG. 3 the second weight member 220 comprises two parts, a first part and a second heavier part 225 as described in FIG. 2 and a first weight member 110 is the same first weight member as the one described in FIG. 1. The vibration apparatus 300 comprises a driving section 330 having a motor 336 and a motor axis serving as a shaft 332 to rotate the weight members. An engaging section 340 forming part of a coupling mechanism is shown between the two weight members. Optionally, also a solenoid coil 344 may be provided as part of the coupling mechanism.

In FIG. 3, the first weight member 110 is connected to the shaft 332 so that the first weight member constituting a small counterweight is rotated when the motor 336 rotates the shaft 332.

In the above discussion, it has been mentioned that the engaging section is part of a coupling mechanism and comprises a ratchet or one-way clutch. However, coupling the first weight member and the second weight member may also be performed differently.

For example, the solenoid coil 344 which is basically an electro-magnet may be used to push out the shaft in the longitudinal direction, i.e. the direction of the rotation axis, relative to the second weight member 220. For example, the second weight member 220 may be held in place by a bearing or similar and in a first state the first weight member 110 may freely rotate next to the second weight member 220, because the first weight member attached to the shaft is moved away to the right from the second weight member 220. In contrast, in the second state (similar to the state shown in the FIG. 3), the solenoid coil moves the first weight member 110 so as the second weight member 220 surrounds the first weight member 110 and couples to it. Here, a coupling mechanism may be easily realized by geometrical forms, e.g. the first weight member has a square shape and the second weight member has a square shaped opening so that the first weight member fits into it. Instead of the solenoid coil constituting a solenoid actuator also a piezoelectric actuator may be used.

It is understood that the solenoid coil is just another way of realizing a coupling mechanism between the two weight members but the preferable way of coupling is to use a ratchet or a one-way clutch, as described above.

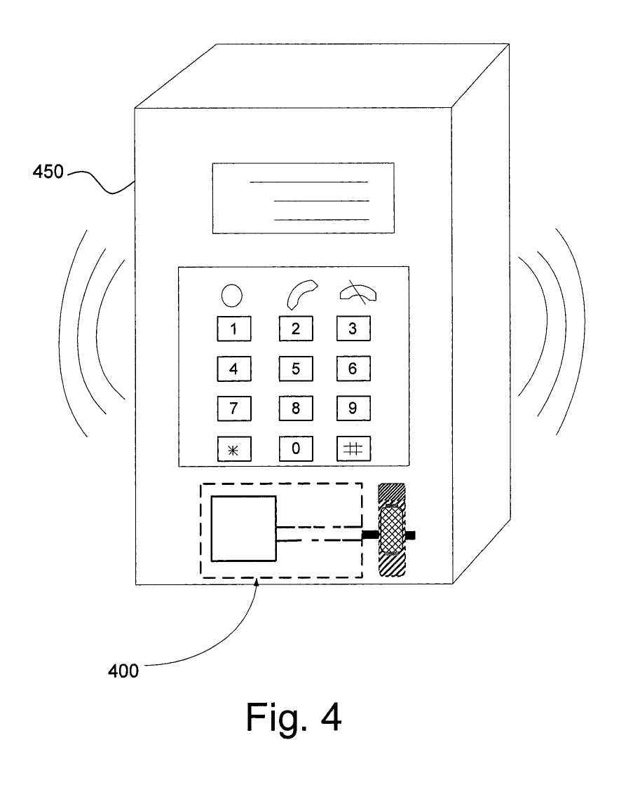

In FIG. 4, a mobile phone 450, in particular a smart phone, having a touch screen display is shown. The touch screen display shows icons, such as icons with digits and call termination and accepting icons. Such a mobile device may greatly benefit from incorporating the vibration apparatus 100, 200 or 300 to allow for different vibration effects. For example, when a command is input in the touch screen constituting a user interface, the input of the command is acknowledged by vibration due to mechanical force effected by the vibration apparatus 400 placed in the mobile phone 450. Similarly, a larger mechanical force to provide a stronger haptic feedback may be provided as an alert in a second state, when rotating the first and the second weight member of the vibration apparatus. Since the vibration apparatus 400 is incorporated inside the mobile phone and is commonly not seen from the outside, it is indicated only by dashed lines.

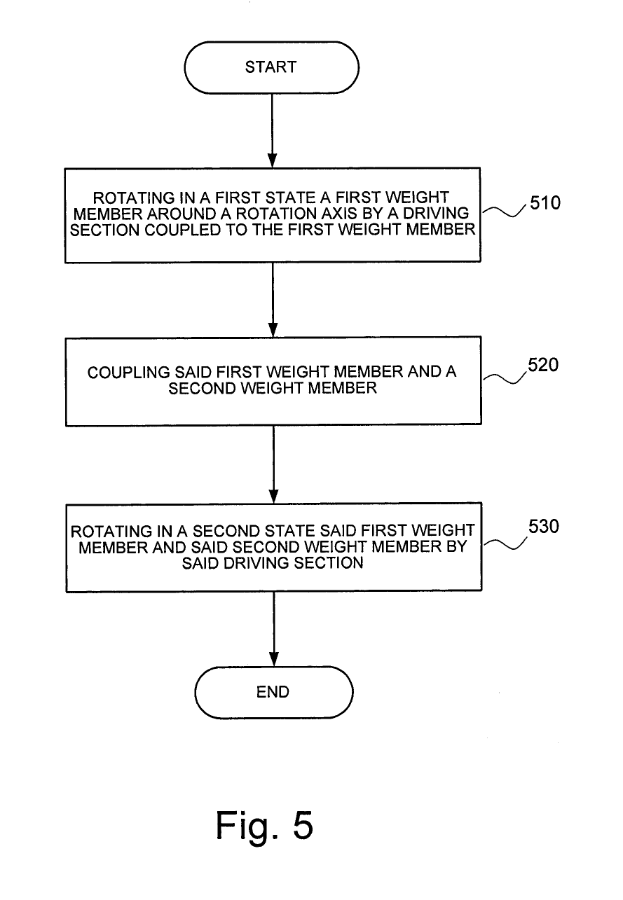

In the following, operations of a method for operating a vibration apparatus, such as the vibration apparatus 100, 200, 300 or 400, will be described with respect to FIG. 5.

In a first step 510 of FIG. 5, a first weight member is rotated, in a first state, around a rotation axis by a driving section, such as driving section 130, which is coupled to the first weight member.

In another step 520, the first weight member and a second weight member are coupled to each other.

Further, in another step 530, the first weight member and the second weight member are rotated in a second state by the driving section.

Accordingly, a first weaker but quickly detectable vibration effect is created as well as a second stronger but delayed vibration effect is created.

It is clear that the operations of the method do not necessarily have to follow in the order shown in FIG. 5 but it is also possible to first couple the two weight members and rotate them together and then decouple the two weight members and rotate only the first weight member.

It will be appreciated that various modifications and variations can be made in the described elements, vibration apparatuses, mobile devices and methods as well in the construction of this invention without departing from the scope or spirit of the invention. The invention has been described in relation to particular embodiments which are intended in all aspects to be illustrative rather than restrictive. Those skilled in the art will appreciate that many different combinations of hardware, software and firmware are suitable for practising the invention.

Moreover, other implementations of the invention will be apparent to the skilled person from consideration of the specification and practice of the invention disclosed herein. It is intended that the specification and the examples are considered as exemplary only. To this end, it is to be understood that inventive aspects may lie in less than all features of the single foregoing disclosed implementation or configuration. Thus, the true scope and spirit of the invention is indicated by the following claims.

1. Vibration apparatus for a hand-held mobile device, comprising
a first weight member;
a second weight member;
a driving section coupled to said first weight member and operable to rotate at least said first weight member around a rotation axis; and
a coupling mechanism adapted to provide coupling between said first weight member and said second weight member so that in a first state said first weight member is rotated by said driving section and in a second state said first weight member and said second weight member are rotated by said driving section.

2. Vibration apparatus of claim 1, wherein said vibration apparatus is adapted to generate a mechanical force to provide haptic feedback to a user by rotation of at least one of said weight members.

3. Vibration apparatus of claim 1, wherein the mass of said first weight member is smaller than the mass of said second weight member and in said first state said vibration apparatus is adapted to generate a weak mechanical force and in said second state said vibration apparatus is adapted to generate a stronger mechanical force.

4. Vibration apparatus of claim 1, wherein said coupling mechanism is adapted to provide coupling between said first weight member and said second weight member so that in said first state the first weight member is rotated in a first direction and in said second state said first weight member and said second weight member are rotated in an opposite second direction.

5. Vibration apparatus of claim 4, wherein said driving section is adapted to change the direction of rotation depending on electric energy supplied thereto so as to provide first haptic feedback in said first direction and second haptic feedback in said second direction.

6. Vibration apparatus of claim 1, wherein the mass of at least one of said first and second weight members is distributed non-uniformly in said at least one of said first and second weight members.

7. Vibration apparatus of claim 1, wherein said driving section comprises a shaft, and said first weight member is attached to said shaft.

8. Vibration apparatus of claim 7, wherein said shaft is off-centered from the center of mass of said first weight member.

9. Vibration apparatus of claim 1, wherein the said first weight member and said second weight member have a substantially cylindrical shape, and wherein said second weight member is arranged around said first weight member.

10. Vibration apparatus of claim 1, wherein said coupling mechanism comprises an engaging section between said first weight member and said second weight member to couple said second weight member and said first weight member.

11. Vibration apparatus of claim 10, wherein said engaging section is adapted to couple said second weight member and said first weight member so that coupling is always performed at the same position of the weight members.

12. Vibration apparatus of claim 10, wherein said engaging section comprises a ratchet or one-way clutch so that said second weight member and said first weight member engage when said first weight member rotates in said opposite second direction and disengage when said first weight member rotates in said first direction.

13. Vibration apparatus of claim 1, wherein said coupling mechanism comprises an electro magnet to move said first weight member in the direction of the rotation axis relative to said second weight member.

14. Vibration apparatus for a hand-held mobile device, comprising
a first weight member;
a second weight member;
means for driving a movement coupled to said first weight member and operable to move at least said first weight member; and
means for providing coupling between said first weight member and said second weight member so that in a first state said first weight member is moved by said means for driving a movement and in a second state said first weight member and said second weight member are moved by said means for driving a movement.

15. Hand-held mobile device comprising said vibration apparatus according to claim 1.

16. Method for operating a vibration apparatus for a hand-held mobile device, comprising the steps
rotating in a first state a first weight member around a rotation axis by a driving section coupled to the first weight member;
coupling said first weight member and a second weight member; and
rotating in a second state said first weight member and said second weight member by said driving section.
